(19) United States
(12) Patent Application Publication
(10) Pub. No.: US 2018/0121894 A1
(43) Pub. Date: May 3, 2018

(54) SYSTEMS AND METHODS FOR TRACKING COMPUTER MESSAGES

(71) Applicant: MasterCard International Incorporated, Purchase, NY (US)

(72) Inventors: Ravi Garg, O'Fallon, MO (US); Brian Archer, St. Peters, MO (US); Stephen David Strohm, Dardenne Prairie, MO (US)

(21) Appl. No.: 15/336,945

(22) Filed: Oct. 28, 2016

(51) Int. Cl. G06Q 20/10; G06Q 40/02

(52) U.S. Cl. CPC G06Q 20/108; G06Q 40/02

(57) ABSTRACT

A message tracking computing device for tracking messages is provided. The message tracking computing device includes a memory in communication with a processor. The processor is programmed to receive user input defining a message tracking scheme, the user input specifying a message index, a tracking duration, and a selected time zone, monitor data signals transmitted over a network, identify at least one candidate message based on the message index, determine, based on a source timestamp included in the at least one candidate message, a corresponding time in the selected time zone for the at least one candidate message, and track, based on the corresponding time for the at least one candidate message, the parameter specified in the message index over the tracking duration.

### BACKGROUND

The present application relates generally to a technology that may be used to assist in tracking computer messages, and more particularly, to network-based systems and methods for synchronizing computer message tracking such that all tracking is processed relative to a predetermined time zone.

Computer-based networks typically include multiple parties transmitting large volumes of messages between one another. To perform data analytics (e.g., to identify anomalous activity) one or more parties may desire to track a number of a particular type of message within a predetermined time period. For example, an issuer of a payment card associated with an account may desire to track a total number of computer messages processed over a network indicating that a financial transactions was conducted using the account during a predetermined time period. During this message tracking, if a number of messages processed over the time period satisfies an alert criteria (e.g., by exceeding a predetermined threshold), an alert may be generated that indicates the possibility of anomalous or fraudulent activity.

In at least some known systems, the initiation and expiration of predetermined time periods for message tracking are typically tied to a time zone associated with the location of a particular party involved in the messaging. For example, in the case of an issuer bank wanting to track transaction messages, the message tracking parameters may be associated with the issuer bank time zone. For example, daily limits (i.e., having a predetermined time period of one day) typically start and expire at the beginning and end of the day for the customer's time zone. However, at least some known systems actually track messages relative to a time zone different than the particular party's time zone, resulting in discrepancies and errors when attempting to accurately calculate the number of messages within a predetermined time period relative to the particular party's time zone.

Accordingly, it is desirable to have a computer system that is capable of being customized to track messages being sent between parties, time-stamping each message using a designated time zone, and applying certain parameters designated by at least one part to the messaging based upon the time-stamping.

### BRIEF DESCRIPTION

In one aspect, a message tracking computing device for tracking messages over a predetermined period of time is provided. The message tracking computing device includes a memory in communication with a processor, the processor programmed to receive user input defining a message tracking scheme, the user input specifying a message index, a tracking duration, and a selected time zone, the message index specifying a parameter to be tracked, monitor data signals transmitted over a network, identify, from the monitored data signals, at least one candidate message based on the message index, determine, based on a source timestamp included in the at least one candidate message, a corresponding time in a selected time zone for the at least one candidate message, and track, based on the corresponding time for the at least one candidate message, the parameter specified in the message index over the tracking duration.

In another aspect, a method for tracking messages over a predetermined period of time is provided. The method is implemented by a message tracking computing device including at least one processor in communication with a memory, the message tracking computing device in communication with a client computing device. The method includes receiving, from a client computing device, user input defining a message tracking scheme, the user input specifying a message index, a tracking duration, and a selected time zone, the message index specifying a parameter to be tracked, monitoring data signals transmitted over a network, identifying, from the monitored data signals, at least one candidate message based on the message index, determining, based on a source timestamp included in the at least one candidate message, a corresponding time in the selected time zone for the at least one candidate message, and tracking, based on the corresponding time for the at least one candidate message, the parameter specified in the message index over the tracking duration.

In a further aspect, a computer-readable storage medium having computer-executable instructions embodied thereon is provided. When executed by a message tracking computing device including at least one processor in communication with a memory, the computer-readable instructions cause the message tracking computing device to receive user input defining a message tracking scheme, the user input specifying a message index, a tracking duration, and a selected time zone, the message index specifying a parameter to be tracked, monitor data signals transmitted over a network, identify, from the monitored data signals, at least one candidate message based on the message index, determine, based on a source timestamp included in the at least one candidate message, a corresponding time in the selected time zone for the at least one candidate message, and track, based on the corresponding time for the at least one candidate message, the parameter specified in the message index over the tracking duration.

### BRIEF DESCRIPTION OF THE DRAWINGS

FIGS. 1-7 show example embodiments of the methods and systems described herein.

FIG. 1 is a schematic diagram illustrating an example multi-party payment card system for enabling payment-by-card transactions and tracking messages in accordance with one embodiment of the present disclosure.

FIG. 2 is an expanded block diagram of an example embodiment of a computer system used in processing payment transactions that includes a message tracking computing device in accordance with one example embodiment of the present disclosure.

FIG. 3 illustrates an example configuration of a server system such as the message tracking computing device of FIG. 2.

FIG. 4 illustrates an example configuration of a client system shown in FIG. 2.

FIG. 5 is a flow diagram of an example method for maintaining a counter as part of a message tracking scheme using the message tracking computing device of FIG. 2.

FIG. 6 is a flow diagram of an example method for tracking messages over a predetermined period of time using the message tracking computing device of FIG. 2.

FIG. 7 is a diagram illustrating operation of a message tracking scheme that uses variable moving windows implemented using the message tracking computing device of FIG. 2.

Although specific features of various embodiments may be shown in some drawings and not in others, this is for convenience only. Any feature of any drawing may be referenced and/or claimed in combination with any feature of any other drawing.

### DETAILED DESCRIPTION

The systems and methods described herein are directed to synchronizing computer message tracking (e.g., message velocity tracking) for transactions processed over a network such that all tracking is processed relative to a predetermined time zone (e.g., an issuer time zone). A message tracking computing device described herein allows a user to create a customized message tracking scheme that tracks computer messages and applies discrete or variable moving windows (tracking parameters), as described herein. More specifically, in the systems and methods described herein, rules are stored that, when applied, automatically identify messages of interest, determine a corresponding time for each message relative to the predetermined time zone, and track those messages based on the corresponding times. By ensuring that all message tracking is processed relative to the predetermined time zone, the message tracking computing device significantly reduces errors in applying these tracking parameters, synchronizing data, and reducing fraudulent transactions.

To facilitate fraud detection, a financial transaction party (e.g., an issuer bank, or issuer) may track message velocities (i.e., the number of transactions conducted during a predetermined period of time) for a cardholder's account by tracking messages (e.g., authorization request and response messages). For example, the issuer may track a total number of transactions conducted using the account during a predetermined time period. Alternatively, the issuer may track a number of transactions conducted with a particular merchant during a predetermined time period. Those of skill in the art will appreciate that message tracking may be performed for many different types of transactions and different types of parameters may be applied in this tracking process. During message tracking, if the number of transactions conducted exceeds a predetermined threshold (i.e., satisfying an alert criteria), the associated account may be flagged for potential fraudulent activity.

In at least some known financial transaction systems, the initiation and expiration of predetermined time periods for message tracking are typically tied to the time zone associated with the location of the issuer (e.g., where the issuer bank is headquartered or where the bank designates as its primary location). For example, daily limits (i.e., having a predetermined time period of one day) typically start and expire at the beginning and end of the day for the issuer's time zone. However, at least some known systems may track messages relative to a time zone different than the issuer's time zone, resulting in discrepancies and errors when attempting to accurately calculate the number of transactions conducted within a predetermined time period relative to the issuer's time zone.

Accordingly, the systems and methods described herein provide a message tracking computing device that facilitates synchronizing tracking (e.g., message velocity tracking) such that all tracking is processed relative to a predetermined time zone (e.g., an issuer time zone). The message tracking computing device described herein also allows a user to create a customized message tracking scheme that tracks messages using discrete or variable moving windows, as described herein. By ensuring that all message tracking is processed relative to the predetermined time zone, the message tracking computing device reduces errors in message tracking.

Using a message tracking scheme that includes discrete or variable moving windows enables tracking messages more accurately by maintaining a moving tracking period having a fixed length. Further, using a message tracking scheme with discrete or variable moving windows facilitates identifying potential fraudulent activity more rapidly.

In the embodiments described herein, the message tracking computing device receives at least one user input in order to generate a message tracking scheme. The message tracking computing device generates the message tracking scheme based on the received user inputs. In the example embodiment, the user inputs include a message index, a tracking duration, and a selected time zone. The selected time zone may be, for example, the time zone associated with the issuer for each transaction.

The message index specifies what particular data will be tracked. For example, the message index may specify that number of transactions associated with a particular primary account number (PAN) should be tracked. Alternatively, the message index may specify that number transactions associated with a particular card identification number (CID) should be tracked, or that transactions associated with a particular issuer or merchant should be tracked. Further, the message index may specify tracking some parameter other than a number of transactions. For example, an average dollar amount or total dollar amount for certain types of transactions may be tracked. Those of skill in the art will appreciate that the message index may specify any suitable parameter for tracking.

The tracking duration specifies the length of the predetermined time period over which the tracking will occur. In the example embodiment, the tracking duration includes a quantity (e.g., 1, 2, 10, 60) and a time unit (e.g., minute, hour, day, month, year). For example, the user may input a tracking duration of 3 hours. In embodiments using variable moving windows, the user may input a specified window size (e.g., a window size of two days). In embodiments using discrete moving windows, the window size is set to 1 (e.g., a single day). Discrete and variable moving windows are described below. In the example embodiment, a predetermined maximum duration is established for each time unit, such that the user cannot specify a tracking duration longer than the predetermined maximum duration.

Once the message tracking scheme is established, to track messages, in the example embodiment, the message tracking computing device monitors transaction signals from a payment network to identify candidate transactions (i.e., transactions having parameters (e.g., issuer associated with a transaction, cardholder PAN, etc.) that match parameters in the messages index). Candidate transactions may also be referred to herein as candidate messages. In some embodiments, the transaction signals monitored by the message tracking computing device are authorization request and response messages approving an associated transaction and transmitted over the payment network.

In the example embodiment, the message tracking computing device identifies a source timestamp associated with each identified candidate transaction. The source timestamp may be included, for example, in the authorization request or response message for the candidate transaction. Notably, the source timestamp may be associated with a time zone other than a selected time zone for the message tracking scheme (e.g., the time zone of the issuer).

In the example embodiment, the message tracking computing device then determines, based on the source timestamp, a corresponding time in the selected time zone for the candidate transaction. For example, when the selected time zone is the issuer's time zone, the message tracking computing device determines the corresponding time in the issuer's time zone. Tracking is then performed in accordance with the message tracking scheme using the corresponding time for the candidate transaction. This is performed for all candidate transactions identified by the message tracking computing device. Accordingly, all candidate transactions are tracked relative to the selected time zones.

In some embodiments, a transaction record is stored for the candidate transaction. The transaction record may include, for example, the source timestamp, the determined corresponding time, the merchant conducting the candidate transaction, the issuer associated with the candidate transaction, the amount (e.g., dollar amount) of the candidate transaction, the PAN used in the candidate transaction, the CID used in the candidate transaction, etc. Message tracking computing device 112 may generate the transaction record, for example, by identifying the pertinent information from the authorization request or response message.

The message tracking computing device then performs rule-based tracking in accordance with the message tracking scheme. For the message tracking scheme, in the example embodiment where discrete moving windows are used, the number of moving windows is equal to the quantity of the specified tracking duration. For example, if the tracking duration specified by the user is 10 hours, there will be 10 windows. When variable moving windows are used, the number of moving windows depends on the window size specified by a user. For example, if the tracking duration specified by the user is 10 hours, and the window size is 2 hours, there will be 5 windows.

Further, in the example embodiment, for discrete moving windows, each window starts at the beginning of the time unit (e.g., minute, hour, day month) of the specified tracking duration relative to the selected time period, and each window expires at the end of the time unit. For variable moving windows, the window expires based on the user-specified window size (e.g., at the end of the second hour in a 2 hour window). Each candidate transaction is placed in the appropriate window based on the determined corresponding time. Also, the tracking period begins with the first time unit during which a transaction is detected. To maintain a moving tracking period, for both discrete and variable moving windows, when the end of the tracking period is reached, the first window is removed, or aged off, and a new window is added.

As described herein, the message tracking computing device tracks a parameter (e.g., number of transactions) within a moving tracking period. The tracked parameter is compared to an alert criteria, and if the tracked parameter satisfies the alert criteria, an alert is generated (e.g., by notifying a user of the message tracking computing device).

The following detailed description of the embodiments of the disclosure refers to the accompanying drawings. The same reference numbers in different drawings may identify the same or similar elements. Also, the following detailed description does not limit the claims.

Described herein are computer systems such as message tracking computing devices. As described herein, all such computer systems include a processor and a memory. However, any processor in a computer device referred to herein may also refer to one or more processors wherein the processor may be in one computing device or a plurality of computing devices acting in parallel. Additionally, any memory in a computer device referred to herein may also refer to one or more memories wherein the memories may be in one computing device or a plurality of computing devices acting in parallel.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the term “database” may refer to either a body of data, a relational database management system (RDBMS), or to both. As used herein, a database may include any collection of data including hierarchical databases, relational databases, flat file databases, object-relational databases, object oriented databases, and any other structured collection of records or data that is stored in a computer system. The above examples are example only, and thus are not intended to limit in any way the definition and/or meaning of the term database. Examples of RDBMS's include, but are not limited to including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

In one embodiment, a computer program is provided, and the program is embodied on a computer readable medium. In an example embodiment, the system is executed on a single computer system, without requiring a connection to a sever computer. In a further embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computing devices. One or more components may be in the form of computer-executable instructions embodied in a computer-readable medium.

As used herein, an element or step recited in the singular and proceeded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

As used herein, the terms “payment device,” “transaction card,” “financial transaction card,” and “payment card” refer to any suitable transaction card, such as a credit card, a debit card, a prepaid card, a charge card, a membership card, a promotional card, a frequent flyer card, an identification card, a prepaid card, a gift card, and/or any other device that may hold payment account information, such as mobile phones, Smartphones, personal digital assistants (PDAs), wearable computing devices, key fobs, and/or any other computing devices capable of providing account information. Moreover, these terms may refer to payments made directly from or using bank accounts, stored valued accounts, mobile wallets, etc., and accordingly are not limited to physical devices but rather refer generally to payment credentials. Each type of payment device can be used as a method of payment for performing a transaction. In addition, consumer card account behavior can include but is not limited to purchases, management activities (e.g., balance checking), bill payments, achievement of targets (meeting account balance goals, paying bills on time), and/or product registrations (e.g., mobile application downloads).

The systems and processes are not limited to the specific embodiments described herein. In addition, components of each system and each process can be practiced independent and separate from other components and processes described herein. Each component and process also can be used in combination with other assembly packages and processes.

The following detailed description illustrates embodiments of the disclosure by way of example and not by way of limitation. It is contemplated that the disclosure has general application to tracking velocities for transactions.

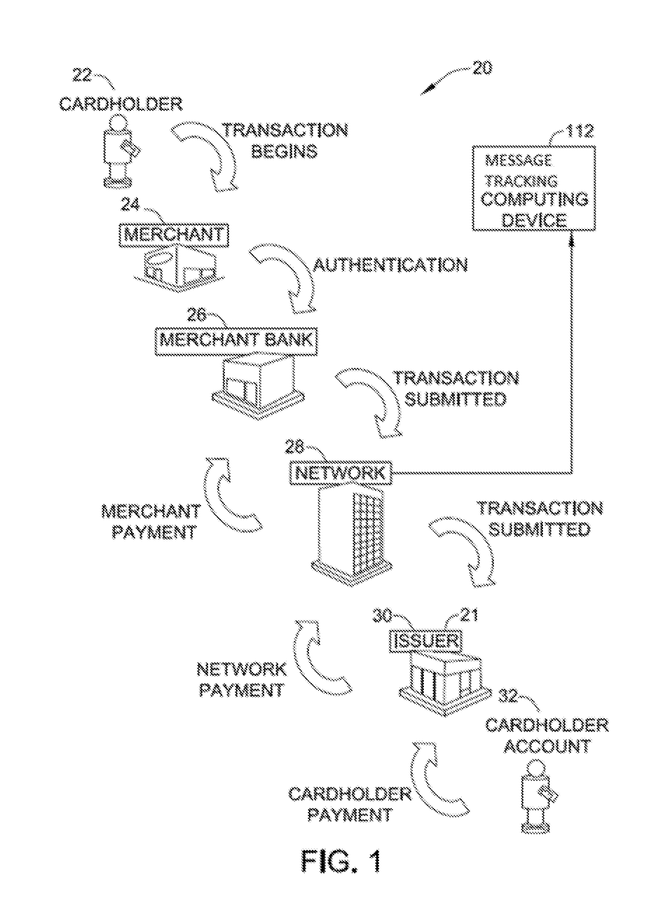

FIG. 1 is a schematic diagram illustrating an example multi-party payment card system 20 for facilitating transactions and tracking messages (e.g., tracking transaction velocity) for those transactions, in accordance with one embodiment of the present disclosure. FIG. 1 depicts a flow of data in a typical financial transaction through system 20, which includes a message tracking computing device 112. Components of system 20 provide message tracking computing device 112 with transaction data, which message tracking computing device 112 processes as described herein.

Embodiments described herein may relate to a transaction card system, such as a credit card payment system using the MasterCard® interchange network. The MasterCard® interchange network is a set of proprietary communications standards promulgated by MasterCard International Incorporated® for the exchange of financial transaction data and the settlement of funds between financial institutions that are members of MasterCard International Incorporated®. (MasterCard is a registered trademark of MasterCard International Incorporated located in Purchase, N.Y.).

In a typical transaction card system, a financial institution called the “issuer” issues a transaction card, such as a credit card, to a consumer or cardholder 22, who uses the transaction card to tender payment for a purchase from a merchant 24. Cardholder 22 may purchase goods and services (“products”) at merchant 24. Cardholder 22 may make such purchases using virtual forms of the transaction card and, more specifically, by providing data related to the transaction card (e.g., the transaction card number, expiration date, associated postal code, and security code) to initiate transactions. To accept payment with the transaction card or virtual forms of the transaction card, merchant 24 must normally establish an account with a financial institution that is part of the financial payment system. This financial institution is usually called the “merchant bank,” the “acquiring bank,” or the “acquirer.” When cardholder 22 tenders payment for a purchase with a transaction card or virtual transaction card, merchant 24 requests authorization from a merchant bank 26 for the amount of the purchase. The request may be performed over the telephone or electronically, but is usually performed through the use of a point-of-sale terminal, which reads cardholder's 22 account information from a magnetic stripe, a chip, or embossed characters on the transaction card and communicates electronically with the transaction processing computers of merchant bank 26. Merchant 24 receives cardholder's 22 account information as provided by cardholder 22. Alternatively, merchant bank 26 may authorize a third party to perform transaction processing on its behalf. In this case, the point-of-sale terminal will be configured to communicate with the third party. Such a third party is usually called a “merchant processor,” an “acquiring processor,” or a “third party processor.”

Using an interchange network 28, computers of merchant bank 26 or merchant processor will communicate with computers of an issuer bank 30 to determine whether cardholder's 22 account 32 is in good standing and whether the purchase is covered by cardholder's 22 available credit line. Based on these determinations, the request for authorization will be declined or accepted. If the request is accepted, an authorization code is issued to merchant 24.

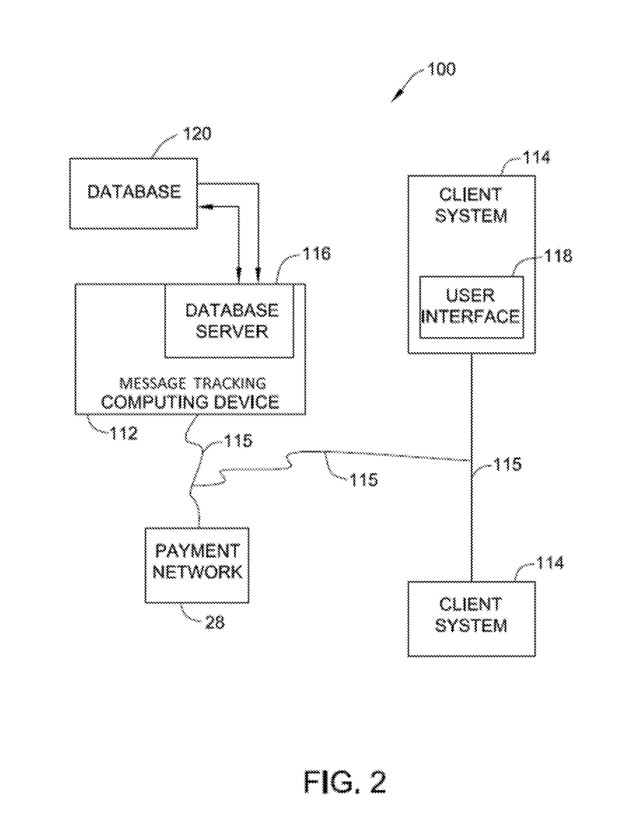

When a request for authorization is accepted, the available credit line of cardholder's 22 account 32 is decreased. Normally, a charge for a payment card transaction is not posted immediately to cardholder's 22 account 32 because bankcard associations, such as MasterCard International Incorporated®, have promulgated rules that do not allow merchant 24 to charge, or “capture,” a transaction until products are shipped or services are delivered. However, with respect to at least some debit card transactions, a charge may be posted at the time of the transaction. When merchant 24 ships or delivers the products or services, merchant 24 captures the transaction by, for example, appropriate data entry procedures on the point-of-sale terminal. This may include bundling of approved transactions daily for standard retail purchases. If cardholder 22 cancels a transaction before it is captured, a “void” is generated. If cardholder 22 returns products after the transaction has been captured, a “credit” is generated. Interchange network 28 and/or issuer bank 30 stores the transaction card information, such as a type of merchant, amount of purchase, date of purchase, in a database 120 (shown in FIG. 2).

After a purchase has been made, a clearing process occurs to transfer additional transaction data related to the purchase among the parties to the transaction, such as merchant bank 26, interchange network 28, and issuer bank 30. More specifically, during and/or after the clearing process, additional data, such as a time of purchase, a merchant name, a type of merchant, purchase information, cardholder account information, a type of transaction, information regarding the purchased item and/or service, and/or other suitable information, is associated with a transaction and transmitted between parties to the transaction as transaction data, and may be stored by any of the parties to the transaction. In the example embodiment, transaction data including such additional transaction data may also be provided to systems including message tracking computing device 112. In the example embodiment, interchange network 28 provides such transaction data (including merchant data associated with merchant tenants of each commercial real estate asset of each portfolio record) and additional transaction data. In alternative embodiments, any party may provide such data to message tracking computing device 112.

After a transaction is authorized and cleared, the transaction is settled among merchant 24, merchant bank 26, and issuer bank 30. Settlement refers to the transfer of financial data or funds among merchant's 24 account, merchant bank 26, and issuer bank 30 related to the transaction. Usually, transactions are captured and accumulated into a “batch,” which is settled as a group. More specifically, a transaction is typically settled between issuer bank 30 and interchange network 28, and then between interchange network 28 and merchant bank 26, and then between merchant bank 26 and merchant 24.

As described below in more detail, message tracking computing device 112 may be used to implement a message tracking scheme to track, for example, transaction velocities. Although the systems described herein are not intended to be limited to facilitate such applications, the systems are described as such for exemplary purposes.

FIG. 2 is an expanded block diagram of an example embodiment of a computer system 100 used in processing payment transactions that includes message tracking computing device 112 in accordance with one example embodiment of the present disclosure. In the example embodiment, system 100 is used for tracking transaction velocities, as described herein.

More specifically, in the example embodiment, system 100 includes message tracking computing device 112, and a plurality of client sub-systems, also referred to as client systems 114, connected to message tracking computing device 112. In one embodiment, client systems 114 are computers including a web browser, such that message tracking computing device 112 is accessible to client systems 114 using the Internet and/or using network 115. Client systems 114 are interconnected to the Internet through many interfaces including a network 115, such as a local area network (LAN) or a wide area network (WAN), dial-in-connections, cable modems, special high-speed Integrated Services Digital Network (ISDN) lines, and RDT networks. Client systems 114 may include systems associated with cardholders 22 (shown in FIG. 1) as well as external systems used to store data. Message tracking computing device 112 is also in communication with payment network 28 using network 115. Further, client systems 114 may additionally communicate with payment network 28 using network 115. Client systems 114 could be any device capable of interconnecting to the Internet including a web-based phone, PDA, or other web-based connectable equipment.

A database server 116 is connected to database 120, which contains information on a variety of matters, as described below in greater detail. In one embodiment, centralized database 120 is stored on message tracking computing device 112 and can be accessed by potential users at one of client systems 114 by logging onto message tracking computing device 112 through one of client systems 114. In an alternative embodiment, database 120 is stored remotely from message tracking computing device 112 and may be non-centralized. Database 120 may be a database configured to store information used by message tracking computing device 112 including, for example, transaction records, as described herein.

Database 120 may include a single database having separated sections or partitions, or may include multiple databases, each being separate from each other. Database 120 may store transaction data generated over the processing network including data relating to merchants, consumers, account holders, prospective customers, issuers, acquirers, and/or purchases made. Database 120 may also store account data including at least one of a cardholder name, a cardholder address, an account number, other account identifiers, and transaction information. Database 120 may also store merchant information including a merchant identifier that identifies each merchant registered to use the network, and instructions for settling transactions including merchant bank account information. Database 120 may also store purchase data associated with items being purchased by a cardholder from a merchant, and authorization request data.

In the example embodiment, one of client systems 114 may be associated with one of acquirer bank 26 (shown in FIG. 1) and issuer bank 30 (also shown in FIG. 1). For example, one of client systems 114 may be a POS device. Client systems 114 may additionally or alternatively be associated with a user (e.g., a commercial real estate owner or lender, a marketing director, a consumer, or any other end user). In the example embodiment, one of client systems 114 includes a user interface 118. For example, user interface 118 may include a graphical user interface with interactive functionality, such that message tracking results, transmitted from message tracking computing device 112 to client system 114, may be shown in a graphical format. A user of client system 114 may interact with user interface 118 to view, explore, and otherwise interact with the message tracking results. A user may also operate user interface 118 to define a message tracking scheme, as described herein. Message tracking computing device 112 may be associated with interchange network 28 and/or may process transaction data.

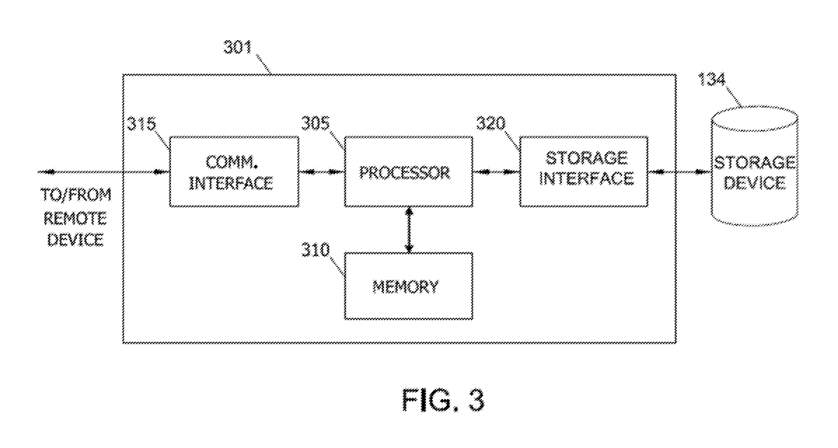

FIG. 3 illustrates an example configuration of a server system 301 such as message tracking computing device 112 (shown in FIGS. 1 and 2), in accordance with one example embodiment of the present disclosure. Server system 301 may also include, but is not limited to, database server 116. In the example embodiment, server system 301 determines and analyzes characteristics of devices used in payment transactions, as described below.

Server system 301 includes a processor 305 for executing instructions. Instructions may be stored in a memory area 310, for example. Processor 305 may include one or more processing units (e.g., in a multi-core configuration) for executing instructions. The instructions may be executed within a variety of different operating systems on the server system 301, such as UNIX, LINUX, Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc.).

Processor 305 is operatively coupled to a communication interface 315 such that server system 301 is capable of communicating with a remote device such as a user system or another server system 301. For example, communication interface 315 may receive requests (e.g., requests to generate a message tracking scheme) from a client system 114 via the Internet, as illustrated in FIG. 2.

Processor 305 may also be operatively coupled to a storage device 134. Storage device 134 is any computer-operated hardware suitable for storing and/or retrieving data. In some embodiments, storage device 134 is integrated in server system 301. For example, server system 301 may include one or more hard disk drives as storage device 134. In other embodiments, storage device 134 is external to server system 301 and may be accessed by a plurality of server systems 301. For example, storage device 134 may include multiple storage units such as hard disks or solid state disks in a redundant array of inexpensive disks (RAID) configuration. Storage device 134 may include a storage area network (SAN) and/or a network attached storage (NAS) system.

In some embodiments, processor 305 is operatively coupled to storage device 134 via a storage interface 320. Storage interface 320 is any component capable of providing processor 305 with access to storage device 134. Storage interface 320 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 305 with access to storage device 134.

Memory area 310 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are examples only, and are thus not limiting as to the types of memory usable for storage of a computer program.

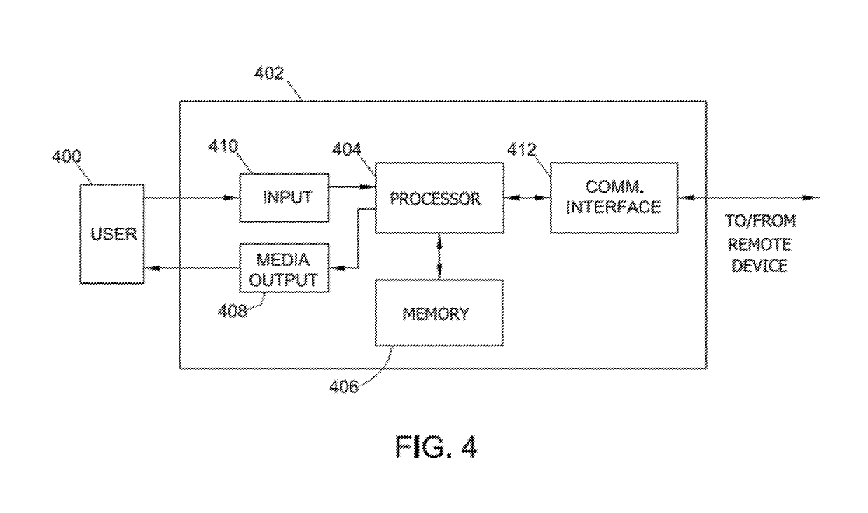

FIG. 4 illustrates an example configuration of a client computing device 402. Client computing device 402 may include, but is not limited to, client systems (“client computing devices”) 114. Client computing device 402 includes a processor 404 for executing instructions. In some embodiments, executable instructions are stored in a memory area 406. Processor 404 may include one or more processing units (e.g., in a multi-core configuration). Memory area 406 is any device allowing information such as executable instructions and/or other data to be stored and retrieved. Memory area 406 may include one or more computer-readable media.

Client computing device 402 also includes at least one media output component 408 for presenting information to a user 400. Media output component 408 is any component capable of conveying information to user 400. In some embodiments, media output component 408 includes an output adapter such as a video adapter and/or an audio adapter. An output adapter is operatively coupled to processor 404 and operatively couplable to an output device such as a display device (e.g., a liquid crystal display (LCD), organic light emitting diode (OLED) display, cathode ray tube (CRT), or “electronic ink” display) or an audio output device (e.g., a speaker or headphones).

In some embodiments, client computing device 402 includes an input device 410 for receiving input from user 400. Input device 410 may include, for example, a keyboard, a pointing device, a mouse, a stylus, a touch sensitive panel (e.g., a touch pad or a touch screen), a camera, a gyroscope, an accelerometer, a position detector, and/or an audio input device. A single component such as a touch screen may function as both an output device of media output component 408 and input device 410.

Client computing device 402 may also include a communication interface 412, which is communicatively couplable to a remote device such as server system 301 or a web server operated by a merchant. Communication interface 412 may include, for example, a wired or wireless network adapter or a wireless data transceiver for use with a mobile phone network (e.g., Global System for Mobile communications (GSM), 3G, 4G or Bluetooth) or other mobile data network (e.g., Worldwide Interoperability for Microwave Access (WIMAX)).

Stored in memory area 406 are, for example, computer-readable instructions for providing a user interface to user 400 via media output component 408 and, optionally, receiving and processing input from input device 410. A user interface may include, among other possibilities, a web browser and client application. Web browsers enable users 400 to display and interact with media and other information typically embedded on a web page or a website from a web server associated with a merchant. A client application allows users 400 to interact with a server application associated with, for example, a merchant. The user interface, via one or both of a web browser and a client application, facilitates display of message tracking results by message tracking computing device 112. The user may also interact with the user interface to define a message tracking scheme, as described herein.

To facilitate fraud detection, a financial transaction party (e.g., an issuer bank, or issuer) may track message velocities (i.e., the number of transactions conducted during a predetermined period of time) for messages processed over a computer-based payment network for a cardholder's account. For example, the issuer may track a total number of transactions conducted over the payment network using the account during a predetermined time period. Alternatively, the issuer may track a number of transactions conducted with a particular merchant over the payment network during a predetermined time period. Those of skill in the art will appreciate that message tracking may be performed for many different types of transactions. During message tracking, if the number of transactions conducted exceeds a predetermined threshold (i.e., satisfying an alert criteria), the associated account may be flagged for potential fraudulent activity.

In at least some known financial transaction systems, the initiation and expiration of predetermined time periods for message velocity tracking are typically tied to the time zone associated with the location of the issuer bank (e.g., where the issuer bank is headquartered or where the bank designates as its primary location). For example, daily limits (i.e., having a predetermined time period of one day) typically start and expire at the beginning and end of the day for the issuer's time zone. However, at least some known systems may track message velocities relative to a time zone different than the issuer's time zone, resulting in discrepancies and errors when attempting to accurately calculate the number of transactions conducted within a predetermined time period relative to the issuer's time zone.

Accordingly, message tracking computing device 112 facilitates synchronizing tracking such that all tracking is processed relative to a predetermined time zone (e.g., an issuer time zone). Message tracking computing device 112 also allows a user to create a message tracking scheme that tracks messages using discrete or variable moving windows, as described herein. By ensuring that all tracking is processed relative to the predetermined time zone, message tracking computing device 112 reduces errors in tracking.

Using a message tracking scheme that includes discrete or variable moving windows, as described herein, enables tracking velocity and other indices more accurately by maintaining a moving tracking period having a fixed length. For example, if the predetermined time is 3 hours, at least some known systems track the number of transactions from 12:00 AM to 3:00 AM, and subsequently track the number of transactions from 3:00 AM to 6:00 AM. However, using discrete moving windows, with a window size of 1 hour, over the same time period, message tracking computing device 112 tracks the number of transactions from 12:00 AM to 3:00 AM, the number of transactions from 1:00 AM to 4:00 AM, the number of transactions from 2:00 AM to 5:00 AM, and the number of transactions from 3:00 AM to 6:00 AM. Accordingly, using a message tracking scheme with discrete or variable moving windows facilitates tracking velocity more accurately and identifying potential fraudulent activity more rapidly.

Message tracking computing device 112 receives at least one user input in order to generate a message tracking scheme. The user inputs may be provided, for example, by a user operating client computing device 402 (shown in FIG. 4). Message tracking computing device 112 generates the message tracking scheme based on the received user inputs. In the example embodiment, the user inputs include a message index, a tracking duration, and a selected time zone. For embodiments using variable moving windows, the user inputs also specify a window size. The user inputs may be selected by the user, for example, from a list of preset choices (e.g., displayed in a drop-down menu). The selected time zone may be, for example, the time zone associated with the issuer for each transaction.

The message index specifies what parameters will be tracked. For example, the message index may specify that number of transactions associated with a particular primary account number (PAN) should be tracked. Alternatively, the message index may specify that number transactions associated with a particular card identification number (CID) should be tracked, or that transactions associated with a particular issuer or merchant should be tracked. Further, the message index may specify tracking some parameter other than a number of transactions (i.e., a velocity). For example, an average dollar amount or total dollar amount for certain types of transactions may be tracked. Those of skill in the art will appreciate that the message index may specify any suitable parameter for tracking.

The tracking duration specifies the length of the predetermined time period over which the message index should be tracked. In the example embodiment, the tracking duration includes a quantity (e.g., 1, 2, 10, 60) and a time unit (e.g., minute, hour, day, month, year). For example, the user may input a tracking duration of 3 hours. In embodiments using variable moving windows, the user may input a specified window size (e.g., a window size of two days). In embodiments using discrete moving windows, the window size is set to 1 (e.g., a single day). In the example embodiment, a predetermined maximum duration is established for each time unit, such that the user cannot specify a tracking duration longer than the predetermined maximum duration. The predetermined maximum durations may be, for example, 60 minutes, 48 hours, 45 days, 12 months, and 3 years. Alternatively, any suitable predetermined maximum durations may be established. Further, in some embodiments, predetermined maximum durations are not included.

Once the message tracking scheme is established, to track the message index, in the example embodiment, message tracking computing device 112 is communicatively coupled to a payment network, and monitors transaction signals from the payment network to identify candidate transactions (i.e., transactions having parameters (e.g., issuer associated with a transaction, cardholder PAN, etc.) that match parameters in the message index). For example, if the message index specifies that all transactions associated with Issuer X should be tracked, message tracking computing device 112 monitors transaction signals to identify transactions involving Issuer X. In some embodiments, the transaction signals monitored by message tracking computing device 112 are authorization request or response messages approving an associated transaction and transmitted over the payment network. Alternatively, message tracking computing device 112 may identify candidate transactions using any suitable method that enables message tracking computing device 112 to function as described herein. For example, in some embodiments, messages identified by message tracking computing device 112 may be in the International Organization for Standardization (ISO) 8583 format. In such embodiments, pertinent information (e.g., issuer associated with a transaction, cardholder PAN, etc.) may be determined by parsing a header, payload, and/or tail of the message. Further, in such embodiments, the source timestamp (described below) may be included in the header, payload, and/or tail of the message.

In the example embodiment, message tracking computing device 112 identifies a source timestamp for each identified candidate transaction. Notably, the source timestamp may be associated with a time zone other than a selected time zone for the message tracking scheme (e.g., the time zone of the issuer). For example, for situations where the selected time zone is the issuer's time zone, the source timestamp may be associated with a time zone in which message tracking computing device 112 is located, and message tracking computing device 112 may be in a different time zone than the issuer. Further, in some embodiments, the source timestamp may be calculated relative to Coordinated Universal Time (UTC).

In the example embodiment, message tracking computing device 112 then determines a corresponding time for each candidate transaction in the selected time zone for the message tracking scheme. For example, when the selected time zone is the issuer's time zone, message tracking computing device 112 determines the corresponding time for the source timestamp in the determined issuer time zone. The time zone of the issuer may be determined, for example, by performing a look-up operation (e.g., in a database coupled to message tracking computing device 112) based on the issuer identified for the candidate transaction. Alternatively, the corresponding time may be determined using any technique that enables message tracking computing device 112 to function as described herein. Tracking in accordance with the message tracking scheme may then be performed based on the corresponding time. This is performed for all candidate transactions identified by message tracking computing device 112. Accordingly, all candidate transactions are tracked relative to the selected time zone. Further, discrete moving windows used for tracking begin and expire relative to the selected time zone, as described herein.

In some embodiments, a transaction record may be stored for each candidate transaction. The transaction record may include, for example, the source timestamp, the corresponding time, the merchant conducting the candidate transaction, the issuer associated with the candidate transaction, the amount (e.g., dollar amount) of the candidate transaction, the PAN used in the candidate transaction, the CID used in the candidate transaction, etc. Message tracking computing device 112 may generate the transaction record, for example, by identifying the pertinent information from the authorization request or response message.

In the example embodiment, message tracking computing device 112 performs rule-based tracking based on the corresponding times in accordance with the message tracking scheme, as described herein. For the message tracking scheme, in the example embodiment using discrete moving windows, the number of discrete moving windows is equal to the quantity of the specified tracking duration. For example, if the tracking duration specified by the user is 10 hours, there will be 10 windows. When variable moving windows are used, the number of moving windows depends on the window size specified by a user. For example, if the tracking duration specified by the user is 10 hours, and the window size is 2 hours, there will be 5 windows.

Each candidate transaction is placed in the appropriate window based on the determined corresponding time. Further, in the example embodiment, for discrete moving windows, each window starts at the beginning of the time unit (e.g., minute, hour, day, month) of the specified tracking duration relative to the selected time period, and each window expires at the end of the time unit. For variable moving windows, the window expires based on the user-specified window size (e.g., at the end of the second hour in a 2 hour window). Also, the tracking period begins with the first time unit during which a transaction is detected. That is, the tracking period is triggered based on the corresponding times of candidate transactions, as described herein. To maintain a moving tracking period, for both discrete and variable moving windows, when the end of the tracking period is reached, the first window is removed, or aged off, and a new window is added.

For example, suppose a message tracking scheme uses discrete moving windows and specifies that all transactions for a particular issuer over a predetermined time period of 30 days should be tracked, with the selected time zone set as the particular issuer's time zone. Accordingly, the tracking period would have 30 windows each having a length of 1 day, and each window would begin at the beginning of the associated day (i.e., 12 AM for the issuer's time zone) and expire at the end of the associated day. The first window of the tracking period would be the day during which the first transaction is detected. For example, if the first transaction fitting the parameters of the message tracking scheme is detected at 3:05 PM in the particular issuer's time zone on September 1, September 1 will be the first window of the tracking period. When the end of the day on September 30 is reached, the September 1 window will be removed from the tracking period, and a new window for October 1 will be added to the tracking period.

As another example, suppose a message tracking scheme uses discrete moving windows, and specifies that all transactions for a particular issuer over a predetermined time period of 3 months should be tracked, with the selected time zone set as the particular issuer's time zone. Accordingly, the tracking period would have 3 windows each having a length of 1 month, and each window would begin at the beginning of the associated month (i.e., 12 AM for the issuer's time zone on the first day of the month) and expire at the end of the associated month. The first window of the tracking period would be the month during which the first transaction is detected. For example, if the first transaction fitting the parameters of the message tracking scheme is detected on March 17, March will be the first window of the tracking period. When the end of May is reached, the March window will be removed from the tracking period, and a new window for June will be added to the tracking period.

As another example, suppose a message tracking scheme uses discrete moving windows and specifies that all transactions for a particular issuer over a predetermined time period of 20 minutes should be tracked, with the selected time zone set as the particular issuer's time zone. Accordingly, the tracking period would have 20 windows each having a length of 1 minute, and each window would begin at the beginning of the associated minute and expire at the end of the associated minute. The first window of the tracking period would be the minute during which the first transaction is detected. For example, if the first transaction fitting the parameters of the message tracking scheme is detected at 12:00:08 PM in the issuer's time zone, 12:00-12:01 PM will be the first window of the tracking period. When 12:20 PM is reached, the 12:00-12:01 PM window will be removed from the tracking period, and a new window from 12:20-12:21 PM will be added to the tracking period.

As yet another example, suppose a message tracking scheme uses discrete moving windows and specifies that all transactions for a particular issuer over a predetermined time period of 5 hours should be tracked, with the selected time zone set as the particular issuer's time zone. Accordingly, the tracking period would have 5 windows each having a length of 1 hour, and each window would begin at the beginning of the associated hour and expire at the end of the associated hour. The first window of the tracking period would be the hour during which the first transaction is detected. For example, if the first transaction fitting the parameters of the message tracking scheme is detected at 12:52 PM in the issuer's time zone, 12:00-1:00 PM will be the first window of the tracking period. When 5:00 PM is reached, the 12:00-1:00 PM window will be removed from the tracking period, and a new window from 5:00-6:00 PM will be added to the tracking period.

Accordingly, as illustrated by the above examples, message tracking computing device 112 tracks a parameter (e.g., number of transactions) within a moving tracking period. The tracked parameter is compared to an alert criteria, and if the tracked parameter satisfies the alert criteria, an alert is generated (e.g., by notifying a user of a client computing device coupled to message tracking computing device 112). For example, suppose the tracked parameter is the number of transactions and the alert criteria specifies that more than 20 transactions per day indicate potential fraudulent activity. Accordingly, if 25 transactions are detected in a single day, an alert indicating potential fraudulent activity will be generated by message tracking computing device.

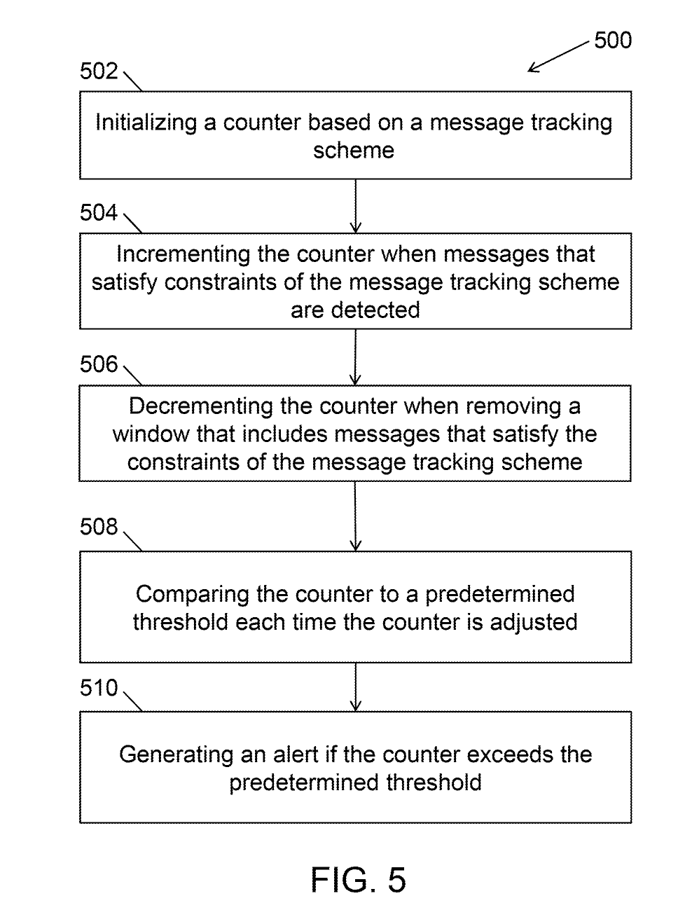

In some embodiments, the parameter is tracked by incrementing and decrementing an associated counter stored in memory (e.g., memory area 310 shown in FIG. 3). FIG. 5 is a flow diagram of an example method 500 for maintaining a counter. Method 500 includes initializing 502 a counter based on a message tracking scheme. For example, suppose the message tracking scheme is configured to track a number of transactions for a particular PAN over a tracking period of 30 days. In this example, initializing 502 the counter includes generating and storing the counter, and setting the counter equal to 0 (i.e., before any transactions for the PAN have been detected).

Method 500 further includes incrementing 504 the counter when messages that satisfy constraints of the message tracking scheme are detected. Returning to the above example, if a transaction for the particular PAN is detected, and that transaction occurs during one of the windows specified by the message tracking scheme, the counter is incremented 504 by 1. Whenever a message satisfying the constraints is detected, a record of that message may be stored (e.g., in memory area 310 shown in FIG. 3). Further, in some embodiments, tracking computing device 112 may generate and display a list of detected messages that satisfy the constraints, allowing a user to determine what specific messages were detected as part of the message tracking scheme.

Further, the counter is decremented 506 as appropriate when a window expires and is removed from the tracking period. Returning to the above example, suppose the first window (i.e., the first day) included 5 transactions for the particular PAN. At the end of the thirtieth day, the first window is removed and a new window is added (i.e., for the thirty-first day). At that time, the counter will be decremented 506 by 5. In this example, stored rules ensure that the counter cannot be less than 0 (i.e., there cannot be a negative number of transactions detected).

In the example embodiment, each time the counter is adjusted (i.e., incremented or decremented) the counter is compared 508 to a predetermined threshold. If the counter exceeds the predetermined threshold, the alert criteria is met, and an appropriate alert is generated 510, as discussed above. Alternatively, the parameter specified by the message tracking scheme may be tracked using any suitable techniques. Method 500 may be used with both discrete and variable moving window techniques.

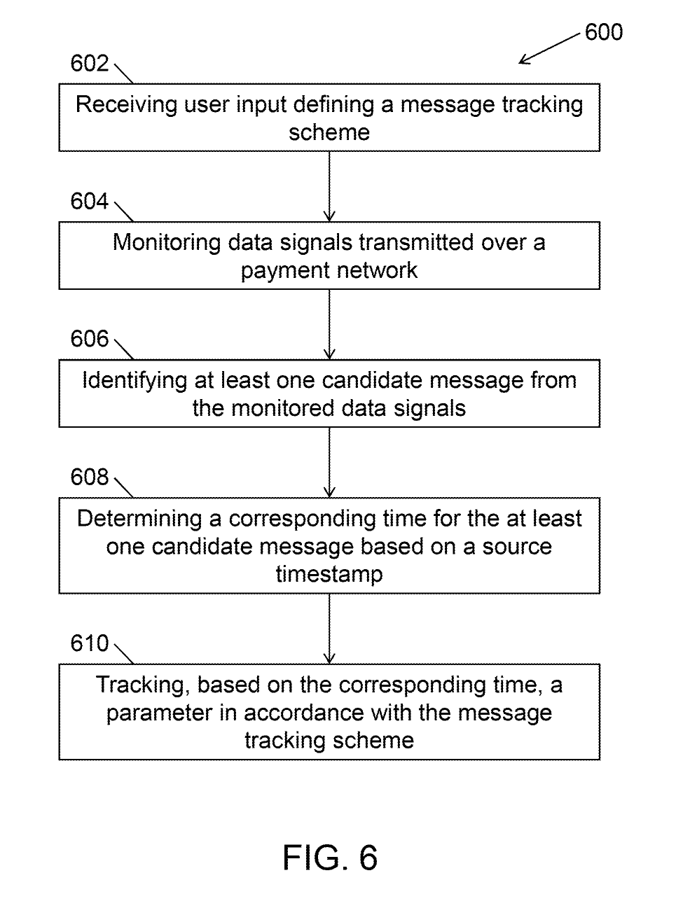

FIG. 6 is a flow diagram of an example method 600 for tracking messages over a predetermined period of time. Method 600 may be implemented, for example, using message tracking computing device 112 (shown in FIG. 3). Method 600 includes receiving 602 user input defining a message tracking scheme, the user input specifying a message index, a tracking duration, and a selected time zone, the message index specifying a parameter to be tracked. Method 600 further includes monitoring 604 data signals transmitted over a payment network. Method 600 further includes identifying 606, from the monitored data signals, at least one candidate message based on the message index.

In the exemplary embodiment, a corresponding time for the candidate message in the selected time zone is determined 608 based on a source timestamp included in the candidate message. Method 600 further includes tracking 610, based on the corresponding time, the parameter specified in the message index over the tracking duration.

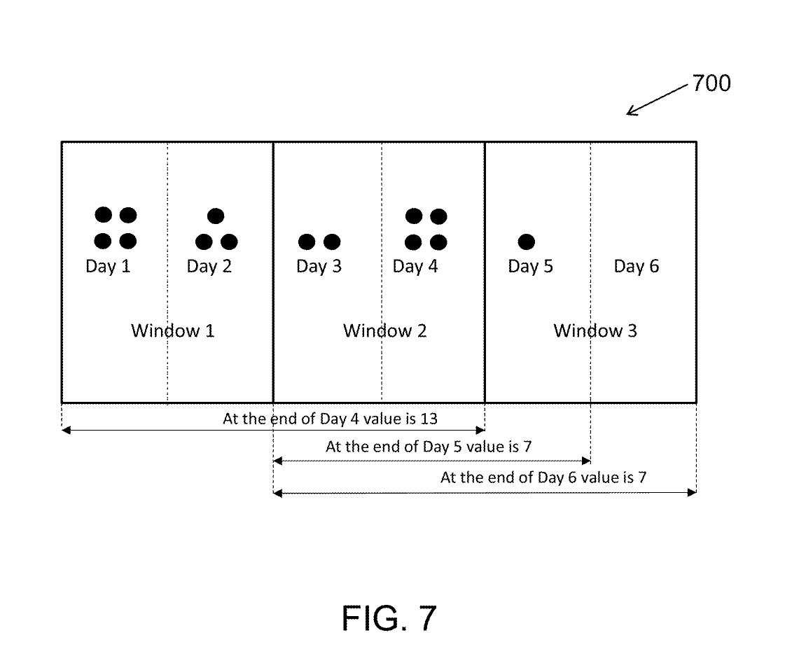

FIG. 7 is a diagram 700 illustrating operation of a message tracking scheme that uses variable, instead of discrete moving windows. Specifically, suppose a message tracking scheme uses variable moving windows and specifies that all transactions for a particular issuer over a predetermined time period of 4 days should be tracked, with the selected time zone set as the particular issuer's time zone. Further, suppose the window size is set to 2 days. Accordingly, the tracking period would have 2 windows each having a length of 2 days, and each window would begin at the beginning of the first day of the window and expire at the end of the second day of the window.

As shown in FIG. 7, suppose that, over a 6 day period, 4 transactions occur on the first day, 3 transactions occur on the second day, 2 transactions occur on the third day, 4 transactions occur on the fourth day, 1 transaction occurs on the fifth day, and 0 transactions occur on the sixth day. Using variable moving windows, at the end of the fourth day, 13 transactions are counted. However, after the fourth day ends, the first window including the first and second days is aged off, and a new third window including the fifth and sixth days is added. Accordingly, at the end of the fifth day, 7 transactions are counted (as the transactions from the first and second days have dropped off). Further, as there are no transactions on the sixth day, the number of transactions counted is still 7 at the end of the sixth day.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

This written description uses examples to disclose the disclosure, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A message tracking computing device for tracking messages over a predetermined period of time, the message tracking computing device comprising a memory in communication with a processor, the processor programmed to:
receive user input defining a message tracking scheme, the user input specifying a message index, a tracking duration, and a selected time zone, the message index specifying a parameter to be tracked;
monitor data signals transmitted over a network;
identify, from the monitored data signals, at least one candidate message based on the message index;
determine, based on a source timestamp included in the at least one candidate message, a corresponding time in the selected time zone for the at least one candidate message; and
track, based on the corresponding time for the at least one candidate message, the parameter specified in the message index over the tracking duration.

2. The message tracking computing device of claim 1, wherein the selected time zone is a time zone of an issuing bank associated with each candidate message, and wherein each candidate message is an ISO 8583 message.

3. The message tracking computing device of claim 1, wherein to track the parameter over the tracking duration, the message tracking computing device is configured to the track the parameter over a moving time period specified by the tracking duration.

4. The message tracking computing device of claim 3, wherein to track the parameter over a moving time period, the message tracking computing device is configured to track the parameter over a moving time period extending from a first discrete window to a last discrete window, wherein, when an end of the last discrete window is reached, i) the first discrete window is removed from the moving time period and ii) a new discrete window is added to the moving time period subsequent to the last window.

5. The message tracking computing device of claim 1, wherein to receive user input defining a message tracking scheme, the message tracking computing device is configured to receive user input specifying a tracking duration that includes a quantity and a time unit.

6. The message tracking computing device of claim 1, wherein the message tracking computing device is further configured to:
compare the tracked parameter to an alert criteria; and
generate an alert if the tracked parameter satisfies the alert criteria.

7. The message tracking computing device of claim 1, wherein to receive user input defining a message tracking scheme, the message tracking computing device is configured to receive user input specifying a variable window size.

8. The message tracking computing device of claim 1, wherein to monitor data signals, the message tracking computing device is configured to monitor authorization response messages transmitted by issuing banks.

9. A method for tracking messages over a predetermined period of time, the method implemented by a message tracking computing device including at least one processor in communication with a memory, the message tracking computing device in communication with a client computing device, said method comprising:
receiving, from a client computing device, user input defining a message tracking scheme, the user input specifying a message index, a tracking duration, and a selected time zone, the message index specifying a parameter to be tracked;
monitoring data signals transmitted over a network;
identifying, from the monitored data signals, at least one candidate message based on the message index;
determining, based on a source timestamp included in the at least one candidate message, a corresponding time in the selected time zone for the at least one candidate message; and
tracking, based on the corresponding time for the at least one candidate message, the parameter specified in the message index over the tracking duration.

10. The method of claim 9, wherein the selected time zone is a time zone of an issuing bank associated with each candidate message, and wherein each candidate message is an ISO 8583 message.

11. The method of claim 9, wherein tracking the parameter over the tracking duration comprises tracking the parameter over a moving time period specified by the tracking duration.

12. The method of claim 11, wherein tracking the parameter over a moving time period comprises tracking the parameter over a moving time period extending from a first discrete window to a last discrete window, wherein, when an end of the last discrete window is reached, i) the first discrete window is removed from the moving time period and ii) a new discrete window is added to the moving time period subsequent to the last window.

13. The method of claim 9, wherein receiving user input comprises receiving user input specifying a tracking duration that includes a quantity and a time unit.

14. The method of claim 9, further comprising:
comparing the tracked parameter to an alert criteria; and
generating an alert if the tracked parameter satisfies the alert criteria.

15. The method of claim 9, wherein receiving user input defining a message tracking scheme comprises receiving user input specifying a variable window size.

16. The method of claim 9, wherein monitoring data signals comprises monitoring authorization response messages transmitted by issuing banks.

17. A computer-readable storage medium having computer-executable instructions embodied thereon, wherein when executed by a message tracking computing device including at least one processor in communication with a memory, the computer-readable instructions cause the message tracking computing device to:
receive user input defining a message tracking scheme, the user input specifying a message index, a tracking duration, and a selected time zone, the message index specifying a parameter to be tracked;
monitor data signals transmitted over a network;
identify, from the monitored data signals, at least one candidate message based on the message index;
determine, based on a source timestamp included in the at least one candidate message, a corresponding time in the selected time zone for the at least one candidate message; and
track, based on the corresponding time for the at least one candidate message, the parameter specified in the message index over the tracking duration.

18. The computer-readable storage medium of claim 17, wherein the selected time zone is a time zone of an issuing bank associated with each candidate message, and wherein each candidate message is an ISO 8583 message.

19. The computer-readable storage medium of claim 17, wherein to track the parameter over the tracking duration, the computer-executable instructions cause the message tracking computing device to the track the parameter over a moving time period specified by the tracking duration.

20. The computer-readable storage medium of claim 19, wherein to track the parameter over a moving time period, the computer-executable instructions cause the message tracking computing device to track the parameter over a moving time period extending from a first discrete window to a last discrete window, wherein, when an end of the last discrete window is reached, i) the first discrete window is removed from the moving time period and ii) a new discrete window is added to the moving time period subsequent to the last window.
